(19) United States
(12) Patent Application Publication
(10) Pub. No.: US 2001/0004065 A1
(43) Pub. Date: Jun. 21, 2001

(54) Process of manufacturing roll punch used for forming partition walls of plasma display panel

(76) Inventors: Sang Jin Oh, Pyungtaek-si (KR); Bong Hyang Kim, Osan-si (KR); Deok Hwan Kim, Pyungtaek-si (KR)

Correspondence Address: BIRCH STEWART KOLASCH & BIRCH, PO BOX 747, FALLS CHURCH, VA, 22040-0747, US

(21) Appl. No.: 09/730,783

(22) Filed: Dec. 7, 2000

(30) Foreign Application Priority Data
Dec. 17, 1999 (KR) 1999 - 58733

(51) Int. Cl. B32B 1/08; B44C 1/22; C23F 1/00

(52) U.S. Cl. 216/10; 216/44; 216/52; 216/59; 216/65

(57) ABSTRACT

A process of manufacturing a roll punch used for forming the partition walls on the rear panel of a PDP is disclosed. In the process of this invention, a forming roll is primarily coated with a mask on its external surface. The mask is, thereafter, partially removed from the forming roll, thus forming a plurality of regularly spaced mask-free parts on the forming roll. The forming roll is, thereafter, etched at the mask-free parts using ultrasonic waves within an etching tank, and so a desired roll punch having partition wall forming grooves is produced. This manufacturing process enlarges the width of the lands between the forming grooves of the roll punch, thus allowing an easy arrangement of address electrodes on the rear panel of a PDP. It is also possible to produce a desired highly precise roll punch by properly adjusting the intervals between the mask-free parts of the forming roll. The roll punch, produced through the process of this invention, preferably enlarges the area of the light emitting part of a PDP.

### BACKGROUND OF THE INVENTION

1. Field of the Invention

The present invention relates to a process of manufacturing a roll punch used for forming the partition walls of a plasma display panel and, more particularly, to an improvement in such a roll punch manufacturing process to chemically form a plurality of partition wall forming grooves on a roll punch using a mask, laser beams and ultrasonic waves, thus effectively producing a highly precise roll punch.

2. Description of the Prior Art

In the prior art, CRTs (cathode ray tubes) have been typically and widely used as displays. However, in response to a requirement for multimedia function as part of an integrated media function capable of processing increased and diversified information in the recent information based society, a variety of plate-type displays have been proposed and used. The displays, including CRTs, are very important elements of information processing systems since most of the processed information of the systems is transferred to people through the visual sense.

Portable information processing systems, designed to be used in the outdoors or in vehicles, are preferably provided with displays accomplishing the recent trend of compactness, lightness, smallness and thinness and being operable with low power. In addition, it is necessary to enlarge the screen-size and visual angle of displays used for displaying public information or public advertisements. Conventional plate-type displays are classified into several types, that is, LCDs (liquid crystal displays), PDPs (plasma display panels) and FED (field emission displays). Of the conventional plate-type displays, the PDPs are in the spotlight as replacements for the CRTs, since the PDPs are effectively reduced in their production cost and easily accomplish desired large size screens using a thick film technique.

In a brief description, the PDPs are more easily produced than the other plate-type displays due to an intrinsic advantage in their manufacturing process when it is desired to produce a display for HDTVs (high definition televisions) having a size of 40″ or more. Therefore, the PDPs have been preferably and widely used as displays for wall-hanging televisions, home theater displays, and a variety of monitors.

Such a PDP is a plate-type display, which is produced using the penning gas discharging technique, and forms a display unit in a plasma display device. The PDPs are typically classified into AC-type panels and DC-type panels in accordance with their discharging types.

The conventional PDP comprises front and rear panels, which are parallely positioned to form a gap between them. In such a PDP, a plurality of display electrodes are formed on the front panel, while a plurality of address electrodes are parallely arranged on the rear panel so as to cross with the display electrodes of the front panel at right angles. In such a case, it is necessary to divide the address electrodes of the rear panel from each other by placing said address electrodes within a plurality of discharge cells. It is thus possible to prevent an undesired mixing of color between the cells and to create effective discharging areas for the address electrodes. In order to accomplish the above object, a plurality of partition walls are regularly formed on the rear panel of the PDP. In addition, red, green and blue fluorescent materials are coated on the address electrodes of the rear panel.

Such partition walls are typically formed on the rear panel by a pressing process using a mechanically molded punch. The conventional punches used for forming such partition walls on the rear panel are classified into plate punches and roll punches.

FIG. 1 is a perspective view, showing a conventional method of manufacturing a plate punch used for forming the partition walls of plasma display panels. As shown in the drawing, a cutting bite 2 linearly and repeatedly moves on the top surface of a forming plate 1 laid on a die (not shown), thus regularly and parallely forming a plurality of partition wall forming grooves 3 on the plate 1 and producing a desired plate punch.

In such a case, the tip 2a of the bite 2 has a vertical length equal to the desired height of each of the target partition walls and a width equal to the desired thickness of each target partition wall. As shown in FIG. 2, the tip 2a of the bite may have two tapered shapes, and so the width of each partition wall forming groove 3 formed on the forming plate 1 is gradually enlarged in a direction from the bottom to the top of the groove 3.

FIG. 3 is a view, showing a conventional method of manufacturing a roll punch used for forming the partition walls on the rear panel of a plasma display panel. As shown in the drawing, a cutting bite 2′, having a tip 2a, forms a plurality of partition wall forming grooves 7 on the external surface of a forming roll 6 integrated with a rotating shaft 5 at its central axis, thus producing a desired roll punch.

However, the conventional method of producing such a plate punch or a roll punch used for forming the partition walls on the rear panel of a PDP is problematic in that the tip 2a of the cutting bite 2 or 2′ is gradually abraded, thus failing to form the partition wall forming grooves 3 having a desired shape or a desired surface smoothness. In addition, a desired strength of the bite 2 or 2′ forces the shape of the tip 2a of the bite 2 or 2′ to be undesirably limited. Due to such a limited shape of the tip 2a, it is very difficult to produce a variety of highly precise rear panels of PDPs.

### SUMMARY OF THE INVENTION

Accordingly, the present invention has been made keeping in mind the above problems occurring in the prior art, and an object of the present invention is to provide a process of manufacturing a roll punch used for forming the partition walls on the rear panel of a PDP, which reduces the width of each partition wall forming groove formed on the external surface of a roll punch, and enlarges the width of each land between the forming grooves, thus allowing an easy arrangement of address electrodes on the rear panel of the PDP and enlarging the area of the light emitting part of the PDP, and which easily and simply produces a desired roll punch.

In order to accomplish the above object, the present invention provides a process of manufacturing a roll punch used for forming the partition walls of a plasma display panel, comprising the steps of: coating a mask on the external surface of a forming roll; partially removing the mask from the forming roll at regularly spaced positions while rotating the forming roll, thus forming an intermediate product having a plurality of regularly spaced mask-free parts; etching the intermediate product at the mask-free parts using ultrasonic waves within an etching tank provided with an ultrasonic vibrator, thus forming a plurality of partition wall forming grooves on the forming roll of the intermediate product; and completely removing the remaining part of the mask from the forming roll having the partition wall forming grooves, thus finally producing a desired roll punch.

In the process of this invention, the inclination angle of each inclined sidewall of each of the partition wall forming grooves of the roll punch relative to a vertical reference line perpendicular to the external surface of lands between the forming grooves is 3° or less.

In addition, the partition wall forming grooves of the roll punch produced through the process of this invention are fabricated such that a value of [h/(b−a)] is 30 or more, wherein “h” is a height of each of the partition walls formed on the plasma display panel by the forming grooves of the roll punch, “b” is a width of the middle portion of the partition wall, and “a” is a width of the top portion of the partition wall.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view, showing a method of manufacturing a conventional plate punch used for forming the partition walls on the rear panel of a plasma display panel;

FIG. 2 is a perspective view of a cutting bite used in the method of FIG. 1;

FIG. 3 is a view, showing a conventional method of manufacturing a roll punch used for forming the partition walls on the rear panel of a plasma display panel;

FIG. 4 is a view, showing a process of manufacturing a roll punch used for forming the partition walls on the rear panel of a plasma display panel in accordance with the preferred embodiment of the present invention;

FIG. 5 is a flowchart of the process of manufacturing the roll punch used for forming the partition walls on the rear panel of a plasma display panel in accordance with this invention; and

FIG. 6 is a front view of a plasma display panel (PDP) produced using the roll punch manufactured through the process of this invention.

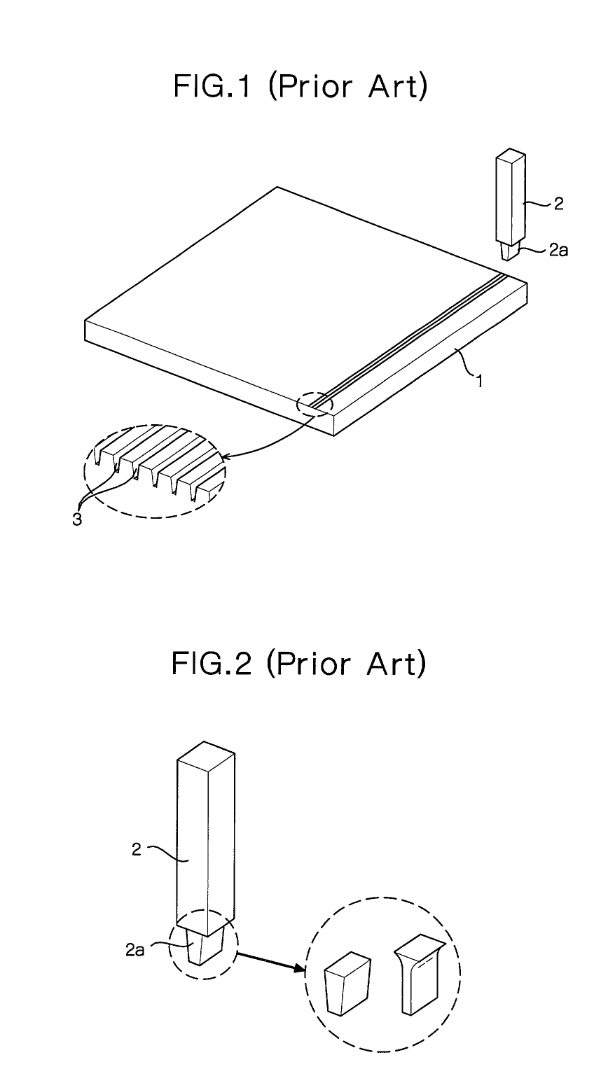

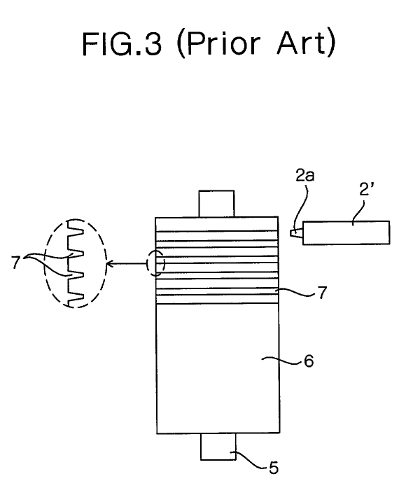

### DETAILED DESCRIPTION OF THE INVENTION

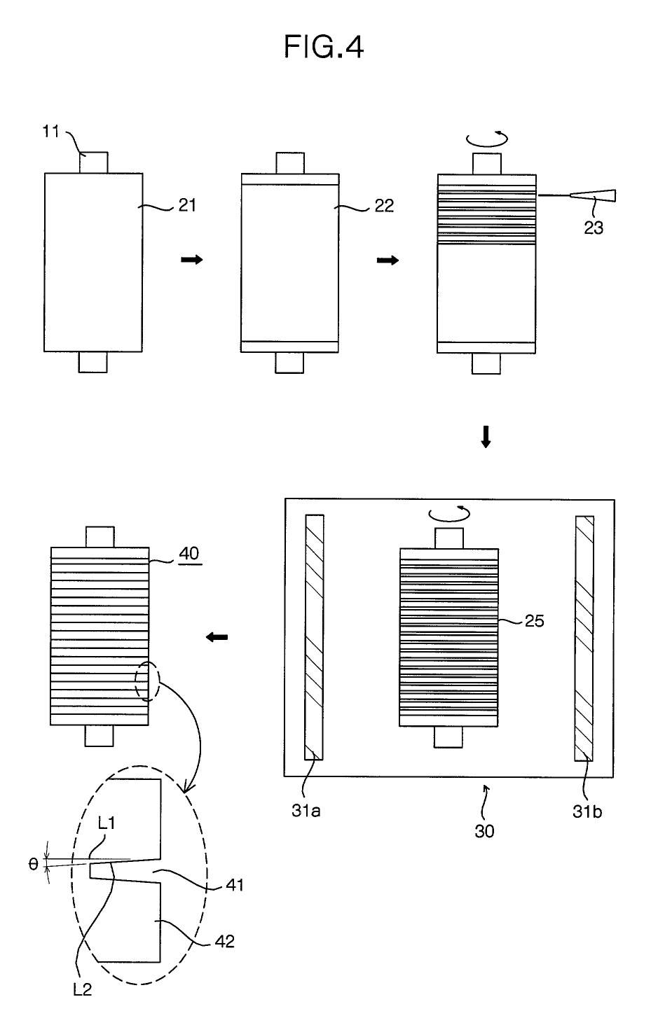

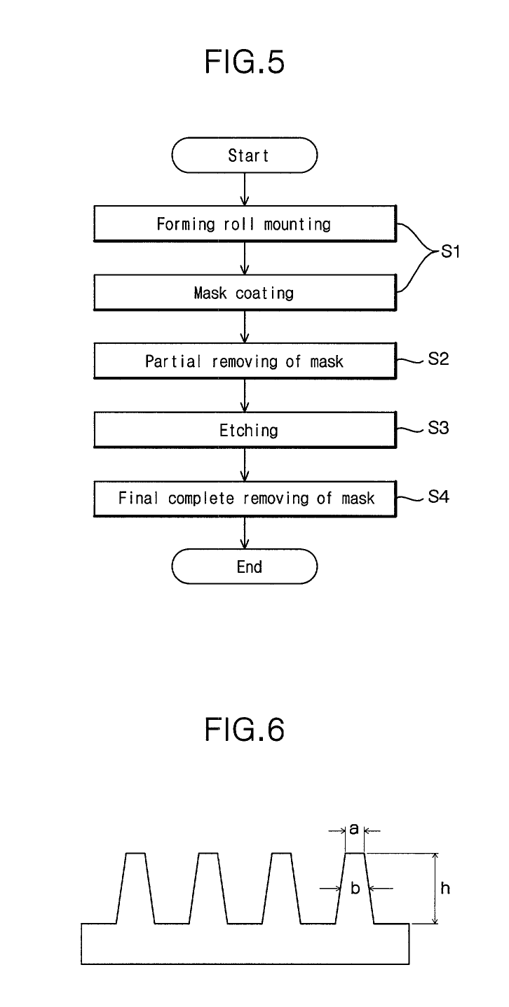

FIG. 4 is a view, showing a process of manufacturing a roll punch used for forming the partition walls on the rear panel of a plasma display panel in accordance with the preferred embodiment of the present invention. FIG. 5 is a flowchart of the process of this invention.

As shown in the drawings, in the process of manufacturing a roll punch in accordance with the preferred embodiment of this invention, a forming roll 21 is concentrically mounted to a unidirectionally rotatable shaft 11 prior to coating a mask 22 on the external surface of the roll 21 at the first step S1.

At the second step S2, the mask 22 is partially removed from the forming roll 21 using a laser beam or a cutting bite 23 at regularly spaced positions, thus forming an intermediate product 25 having a plurality of regularly spaced mask-free parts where desired partition wall forming grooves 41 are to be formed at later step. In the second step S2, the forming roll 21 is rotated in a direction.

In the present invention, it is possible to produce a desired highly precise roll punch by properly adjusting the intervals between the mask-free parts of the intermediate product 25 at said second step S2.

The intermediate product 25 from the second step S2 is, thereafter, sunk and fixed in an etching tank 30 at the third step S3. In such a case, two ultrasonic vibrators 31a and 31b are placed within the etching tank 30 at opposite positions, and so the forming roll 21 of the intermediate product 25 is partially etched at the regularly spaced mask-free parts by ultrasonic waves radiated from the two ultrasonic vibrators 31a and 31b. Therefore, desired partition wall forming grooves 41 are formed on the forming roll 21 of the intermediate product 25 at the mask-free parts.

After the etching process of the third step S3 is completely finished, the intermediate product 25 is removed from the etching tank 30 prior to completely removing the remaining mask 22 from the external surface of the forming roll 21 at the fourth step S4, thus finally producing a desired roll punch 40.

In the resulting roll punch 40 produced through the above-mentioned process, the minus gradient, that is, the inclination angle θ of each inclined sidewall L2 of each forming groove 41 relative to a vertical reference line L1 perpendicular to the external surface of the lands 42 between the grooves 41 is 3° or less.

Each partition wall, formed on the rear panel of a PDP using the roll punch 40, has almost vertical sidewalls as shown in FIG. 6. That is, the value of [h/(b−a)] is 30 or more, wherein “h” is the height of each partition wall, “b” is the width of the middle portion of the partition wall, and “a” is the width of the top portion of the partition wall, and so each partition wall has almost vertical sidewalls.

In addition, the width of each land 42 of the roll punch 40 is enlarged in comparison with the conventional roll punches, and so it is possible to allow an easy arrangement of address electrodes on the rear panel of a PDT.

As described above, the present invention provides a process of manufacturing a roll punch used for forming the partition walls on the rear panel of a PDP. In the process of this invention, a forming roll is primarily coated with a mask on its external surface. Thereafter, the mask is partially removed from the forming roll, thus forming a plurality of regularly spaced mask-free parts on the forming roll. The forming roll is, thereafter, etched at the mask-free parts using ultrasonic waves within an etching tank, and so a desired roll punch having partition wall forming grooves is produced. The roll punch manufacturing process of this invention thus enlarges the width of the lands between the forming grooves of the roll punch, thus allowing an easy arrangement of address electrodes on the rear panel of a PDP. In addition, it is possible to produce a desired highly precise roll punch by properly adjusting the intervals between the mask-free parts of the forming roll. The roll punch, produced through the process of this invention, preferably enlarges the area of the light emitting part of a PDP by about 15% in comparison with conventional roll punches.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A process of manufacturing a roll punch used for forming partition walls of a plasma display panel, comprising the steps of:
coating a mask on an external surface of a forming roll;
partially removing the mask from said forming roll at regularly spaced positions while rotating said forming roll, thus forming an intermediate product having a plurality of regularly spaced mask-free parts;
etching said intermediate product at the mask-free parts using ultrasonic waves within an etching tank provided with an ultrasonic vibrator, thus forming a plurality of partition wall forming grooves on said forming roll of the intermediate product; and
completely removing a remaining part of said mask from the forming roll having the partition wall forming grooves, thus finally producing a roll punch.

2. The process according to claim 1, wherein the partial removal of said mask from the forming roll at the regularly spaced positions is carried out by radiating a laser beam on the mask.

3. The process according to claim 1, wherein the partial removal of said mask from the forming roll at the regularly spaced positions is carried out by a cutting bite.

4. The process according to claim 1, wherein an inclination angle of each inclined sidewall of each of said partition wall forming grooves of the roll punch relative to a vertical reference line perpendicular to an external surface of lands between said forming grooves is 3° or less.

5. The process according to claim 1, wherein the partition wall forming grooves of the roll punch are fabricated such that a value of [h/(b−a)] is 30 or more, wherein “h” is a height of each of the partition walls formed on the plasma display panel by said forming grooves of the roll punch, “b” is a width of a middle portion of said partition wall, and “a” is a width of a top portion of said partition wall.
